(19) United States
(12) Patent Application Publication
(10) Pub. No.: US 2014/0182884 A1
(43) Pub. Date: Jul. 3, 2014

(54) CABLE

(71) Applicants: Naoki Yonezawa, Kanagawa (JP); Kenji Sugihara, Tokyo (JP); Jun Kuwata, Toyko (JP)

(72) Inventors: Naoki Yonezawa, Kanagawa (JP); Kenji Sugihara, Tokyo (JP); Jun Kuwata, Toyko (JP)

(73) Assignee: Panasonic Corporation, Osaka (JP)

(21) Appl. No.: 14/240,557

(22) PCT Filed: Aug. 24, 2012
(86) PCT No.: PCT/JP2012/005330

§ 371 Date: Feb. 24, 2014

(30) Foreign Application Priority Data
Aug. 24, 2011 (JP) 2011-182584

(51) Int. Cl. H01B 9/00

(52) U.S. Cl. CPC H01B 9/00
USPC 174/113 R

(57) ABSTRACT

A cable wherein it is possible to prevent a pair of conductors from coming into contact with one another by disposing an inner insulator between the pair of conductors, and to prevent damages to a power source circuit and such caused by the flow of overcurrent. A cable (100) is used when supplying power to a storage battery on a moving body. A first conductor (101) is connected to a positive electrode. A second conductor (102) is connected to a negative electrode. A third insulator (106) is disposed between the first conductor (101) and the second conductor (102), thereby preventing the first conductor (101) and the second conductor (102) from coming into contact with one another. A fourth insulator (107) covers the first conductor (101), the second conductor (102), and the third insulator (106).

### TECHNICAL FIELD

The present invention relates to a cable for use in supplying electric power to a mobile object such as a vehicle.

### BACKGROUND ART

Conventionally, in a vehicle running with a storage battery as a power source, such as an electric vehicle, a charger mounted in the vehicle is connected to a commercial power supply or a home power supply outside the vehicle through a power feeding cable in order to charge the mounted storage battery (for example, Patent Literature [PTL] 1). The power feeding cable is provided with a pair of conductors respectively connected to a positive electrode and a negative electrode. The paired conductors are each covered with an insulator so as not to contact each other.

### CITATION LIST

### Patent Literature

PTL 1

Japanese Patent Application Laid-Open No. 2010-4674

### SUMMARY OF INVENTION

### Technical Problem

In the case of power feeding cables of the related art, there is, however, a possibility that the insulator covering each of the conductor is damaged and causes contact between the paired conductors in the cable when a vehicle moves during charge and accidentally steps on the power feeding cable. Supplying electric power in this state by connecting the paired conductors in the cable to the power supply causes a problem in that an overcurrent flows and damages a power supply circuit, for example.

It is an object of the present invention to provide a cable which can prevent contact between a pair of conductors and can prevent the damage on a power circuit or the like due to the flow of an overcurrent by providing an internal insulator between the paired conductors.

### Solution to Problem

A cable according to an aspect of the present invention is a cable for use in supplying electric power to a storage battery mounted in a mobile object, the cable including: a first conductor that is connected to a positive electrode; a second conductor that is connected to a negative electrode; an internal insulator that is arranged between the first conductor and the second conductor and that prevents contact between the first conductor and the second conductor; and an external insulator that covers the first conductor, the second conductor, and the internal insulator.

### Advantageous Effects of Invention

A cable according to the present invention can prevent contact between a pair of conductors and can prevent the damage on a power circuit or the like due to the flow of an overcurrent by providing an internal insulator between the paired conductors.

### BRIEF DESCRIPTION OF DRAWINGS

FIG. 1 illustrates a configuration of a charge system in an embodiment of the present invention;

FIG. 2 is a sectional view of a cable according to the embodiment of the present invention;

FIG. 3 is a sectional view of the cable according to the embodiment of the present invention when external force is applied to the cable in the X direction;

FIG. 4 is the sectional view of the cable according to the embodiment of the present invention when external force is applied to the cable in the Y direction; and

FIG. 5 is a sectional view of the cable according to a variation of the embodiment of the present invention.

### DESCRIPTION OF EMBODIMENT

Hereinafter, the embodiment according to the present invention will be explained in detail with reference to the accompanying drawings.

### Embodiment

### Configuration of Charge System

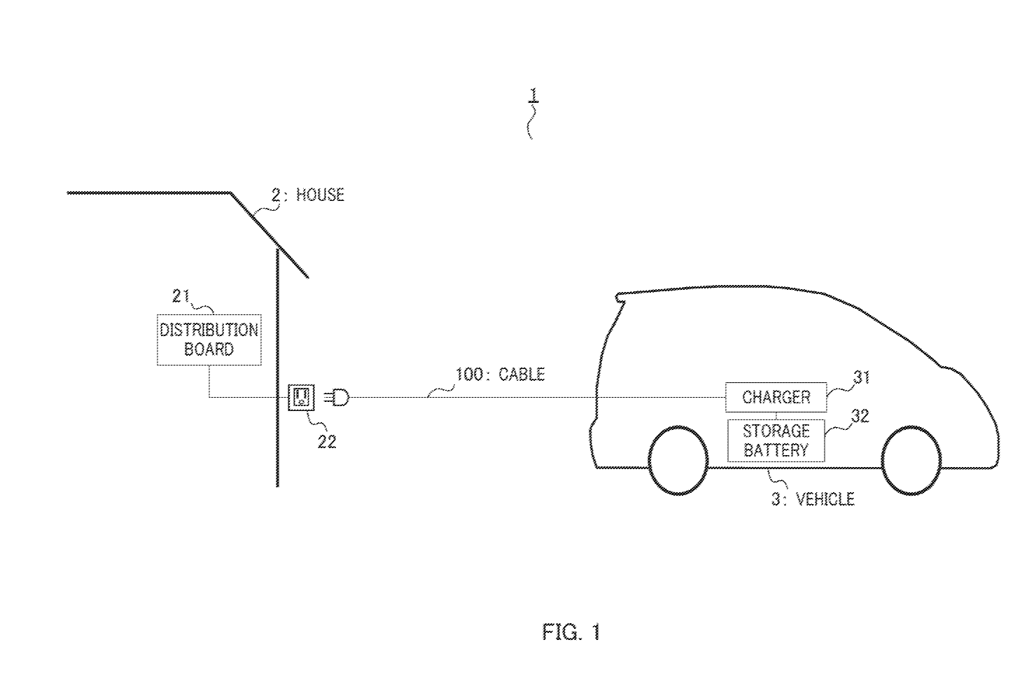

FIG. 1 illustrates a configuration of charge system 1 in an embodiment of the present invention.

Charge system 1 includes house 2, vehicle 3, and cable 100.

House 2 includes distribution board 21 and electric outlet 22. House 2 is, for example, a house of the owner of vehicle 3.

Vehicle 3 includes charger 31 and storage battery 32 and runs on storage battery 32 as a power source. Vehicle 3 is a passenger vehicle, such as an electric vehicle. Vehicle 3 may be not only a passenger vehicle but also a forklift, a crane truck, or the like mounting a storage battery, other than a passenger vehicle.

For charging storage battery 32, cable 100 connects electric outlet 22 and charger 31 and supplies electric power acquired from electric outlet 22 to charger 31 of vehicle 3.

Distribution board 21 supplies electric power acquired from an AC power supply such as a home power supply or a commercial power supply (not illustrated) to electric outlet 22.

Electric outlet 22 is embedded, for example, in the inner wall of house 2, connected to distribution board 21 and supplied with electric power from distribution board 21.

For charging storage battery 32, charger 31 is connected to cable 100 and supplies electric power acquired from electric outlet 22 through cable 100 to storage battery 32.

Storage battery 32 stores the electric power supplied by charger 31.

### Configuration of Cable

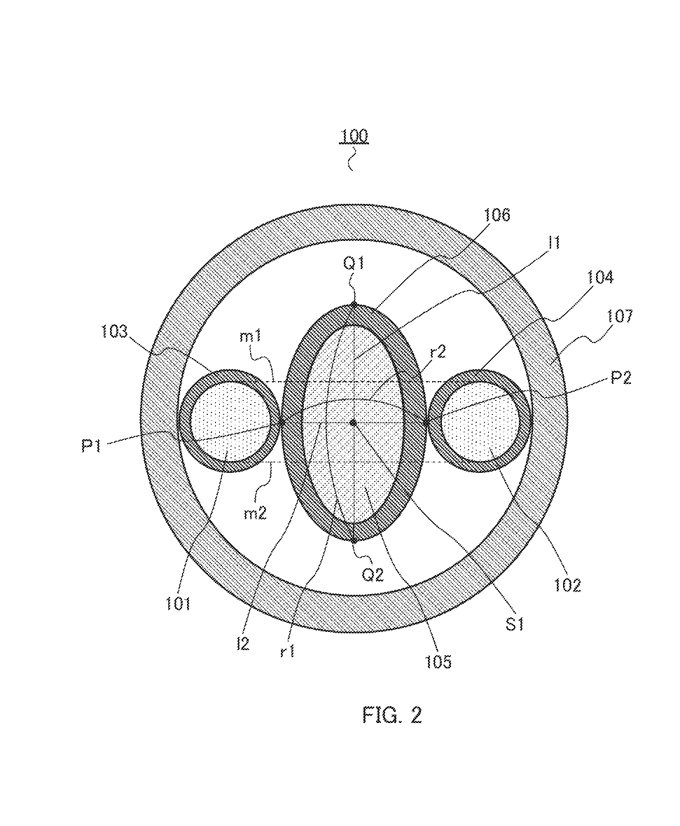

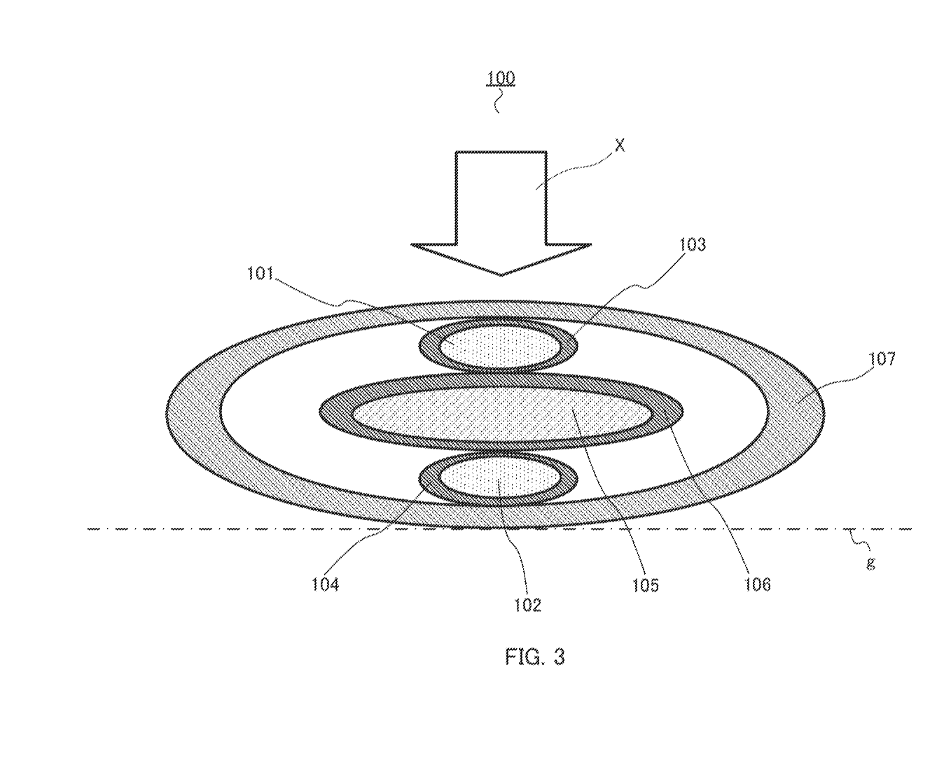

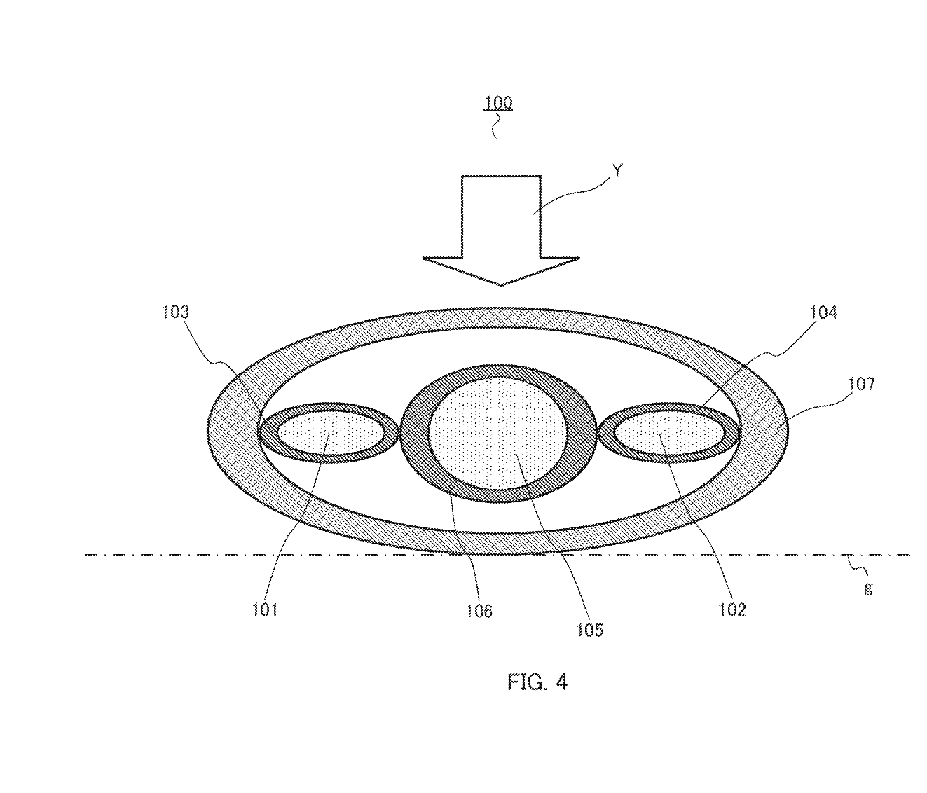

FIG. 2 is a sectional view of cable 100 according to the embodiment of the present invention. FIG. 3 is a sectional view of cable 100 when external force is applied to cable 100 in the X direction. FIG. 4 is a sectional view of cable 100 when external force is applied in the Y direction to cable 100.

Cable 100 includes first conductor 101, second conductor 102, first insulator 103, second insulator 104, ground wire 105, third insulator 106 (internal insulator), and fourth insulator 107 (external insulator).

First conductor 101 is connected to the positive electrode of AC power supply such as a home power supply or a commercial power supply (not illustrated) during charge.

Second conductor 102 is connected to the negative electrode of the AC power supply, which is a home power supply or a power supply, during charge.

First insulator 103 covers and protects first conductor 101 to prevent contact between first conductor 101 and another conductor.

Second insulator 104 covers and protects second conductor 102 to prevent contact between second conductor 102 and another conductor.

Ground wire 105 is provided coaxially with cable 100. Ground wire 105 is provided between first conductor 101 and second conductor 102. Ground wire 105 is covered with third insulator 106.

Third insulator 106 covers ground wire 105. Third insulator 106 is provided coaxially with cable 100. Third insulator 106 contacts first insulator 103 and second insulator 104.

Third insulator 106 is provided so as to traverse two imaginary tangential lines m1 and m2 which each contact the outer periphery of first conductor 101 and the outer periphery of second conductor 102 and which do not cross each other between first conductor 101 and second conductor 102 on a cross section orthogonal to axis Si of cable 100 (hereinafter referred to as “orthogonal cross section”). Third insulator 106 is formed in a flat shape in which length r1 of longest straight line 11 connecting two points Q1 and Q2 on the outer periphery is larger than length r2 of straight line 12 connecting two P1 and P2 on the outer periphery orthogonal to longest straight line 11 on the orthogonal cross section. Longest straight line 11 crosses two imaginary tangential lines ml and m2. Here, the flat shape on the orthogonal cross section includes an ellipse and a rectangle in the orthogonal cross section. In the present embodiment, third insulator 106 is provided so that straight line 12 may not cross imaginary tangential lines m1 and m2. However, the present invention is not limited to this configuration. Third insulator 106 may be provided so that both longest straight line 11 and straight line 12 cross imaginary tangential lines m1 and m2.

Fourth insulator 107 covers first conductor 101, second conductor 102, first insulator 103, second insulator 104, ground wire 105, and third insulator 106.

### Regarding Deformation of Cable When External Force is Applied

When external force is applied to cable 100 in direction X (direction in which first conductor 101 approaches second conductor 102) while cable 100 is placed on ground surface g in the direction illustrated in FIG. 3, first conductor 101, second conductor 102, first insulator 103, second insulator 104, ground wire 105, third insulator 106, and fourth insulator 107 are crushed and deformed. The external force applied in direction X is force applied from a wheel of vehicle 3 to cable 100, for example, when the wheel steps on cable 100.

However, third insulator 106 is provided between first conductor 101 and second conductor 102 in cable 100, thus preventing contact between first conductor 101 and second conductor 102 even if first insulator 103 and second insulator 104 are damaged. Furthermore, third insulator 106 is formed in a flat shape in which length r1 of longest straight line 11 is larger than length r2 of straight line 12 on the orthogonal cross section when cable 100 is deformed. Accordingly, it is possible to prevent contact between first conductor 101 and second conductor 102 even if first insulator 103 and second insulator 104 are damaged. Moreover, even when third insulator 106 is damaged in addition to first insulator 103 and second insulator 104, first conductor 101 and second conductor 102 contact ground wire 105, so that the current can be grounded through ground wire 105.

When external force is applied in direction Y orthogonal to direction X while cable 100 is placed on ground surface g in the direction illustrated in FIG. 4, first conductor 101, second conductor 102, first insulator 103, second insulator 104, ground wire 105, third insulator 106, and fourth insulator 107 are crushed and deformed. The external force applied in direction Y is force applied from a wheel of vehicle 3 to cable 100, for example, when the wheel steps on cable 100.

However, third insulator 106 is provided between first conductor 101 and second conductor 102 in cable 100, so that it is possible to prevent contact between first conductor 101 and second conductor 102 even if first insulator 103 and second insulator 104 are damaged. Furthermore, first conductor 101 and second conductor 102 are pressed in the direction of being separated from each other by third insulator 103 on the orthogonal cross section when cable 100 is deformed. Accordingly, it is possible to prevent contact between first conductor 101 and second conductor 102 even if first insulator 103 and second insulator 104 are damaged. Moreover, even if third insulator 106 is damaged in addition to first insulator 103 and second insulator 104, first conductor 101 and second conductor 102 contact ground wire 105, so that the current can be grounded through ground wire 105.

### Advantageous Effects of Present Embodiment

According to the present embodiment, providing the internal insulator preventing the short circuit of the paired conductors between the conductors makes it possible to prevent contact between the paired conductors. Thus, a power circuit or the like can be prevented from being damaged due to the flow of an overcurrent.

Moreover, according to the present embodiment, the ground wire is provided between the first conductor and the second conductor. Therefore, even if the insulator covering each of the paired conductors is damaged, the current flowing through the first conductor and the second conductor can be grounded through the ground wire.

Moreover, according to the present embodiment, on the orthogonal cross section, the third insulator is provided so as to traverse the two imaginary tangential lines which each contact the outer periphery of the first conductor and the outer periphery of the second conductor and which do not cross each other between the first conductor and the second conductor. Thus, it is made possible to surely prevent contact between the paired conductors when external force is applied to the cable in direction X.

Moreover, according to the present embodiment, the third insulator is formed in a flat shape on the orthogonal cross section so that the outer diameter of the cable can be reduced.

Moreover, according to the present embodiment, when external force is applied in Y direction to the cable, the first conductor and the second conductor are pressed in the direction of being separated from each other by the third insulator, which in turn, makes it possible to surely prevent contact between the paired conductors.

### Variations of Present Embodiment

In the above-described embodiment, the ground wire is covered with the third insulator, but the present invention is not limited to this configuration. The third insulator may be provided alone without the ground wire. Alternatively, an exposed ground wire may be provided without covering the ground wire with the third insulator.

In the above-mentioned embodiment, the power feeding conductors and the ground wire are provided, but the present invention is not limited to this configuration. A control signal line or the like may be provided in addition to the power feeding conductors and the ground wire.

In the above-described embodiment, the cable is connected to AC power supply, but the present invention is not limited to this configuration. The cable may be connected to a DC power supply.

In the above-described embodiment, the third insulator is provided to contact the first insulator and the second insulator, but the present invention is not limited to this configuration. The third insulator may be separated from the first insulator and the second insulator. In this case, when external force is applied to the cable in Y direction, the first conductor and the second conductor may be unpressed in the direction of being separated from each other by the third insulator.

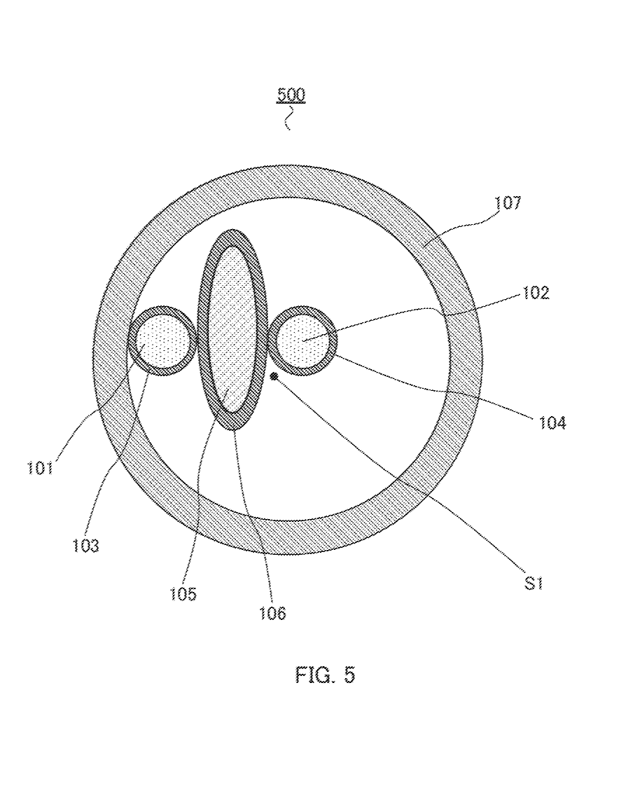

In the above-described embodiment, the ground wire and the third insulator are provided coaxially with the cable. However, the present invention is not limited to this configuration and may employ a configuration illustrated in FIG. 5.

FIG. 5 is a sectional view of cable 500 according to a variation of the present embodiment. In FIG. 5, the same elements as those in FIG. 2 are designated with the same reference numerals, and their repetitive descriptions will be omitted.

As illustrated in FIG. 5, ground wire 105 and third insulator 106 may be placed out of axis S1 of cable 500.

The disclosure of Japanese Patent Application No. 2011-182584, filed on Aug. 24, 2011, including the specification, drawings and abstract, is incorporated herein by reference in its entirety.

### INDUSTRIAL APPLICABILITY

The present invention is suitable for a cable for use in supplying electric power to a mobile object such as a vehicle.

### REFERENCE SIGNS LIST

100 Cable

101 First conductor

102 Second conductor

103 First insulator

104 Second insulator

105 Ground wire

106 Third insulator

107 Fourth insulator

1-4. (canceled)

5. A cable for use in supplying electric power to a storage battery mounted in a mobile object, the cable comprising:
a first conductor that is connected to a positive electrode;
a second conductor that is connected to a negative electrode;
a first insulator that covers the first conductor;
a second insulator that covers the second conductor;
a ground wire that is arranged between the first conductor and the second conductor;
a third insulator that covers the ground wire; and
a fourth insulator that covers the first conductor, the second conductor, the first insulator, the second insulator, the ground wire, and the third insulator; wherein:
the third insulator is configured so that a longest straight line connecting two points on an outer periphery of the third insulator traverses two imaginary tangential lines which each contact an outer periphery of the first conductor and an outer periphery of the second conductor and which do not cross each other between the first conductor and the second conductor, on a cross section orthogonal to an axis of the cable; and
the ground wire is configured so that a longest straight line connecting two points on an outer periphery of the ground wire traverses the two imaginary tangential lines on the cross section orthogonal to the axis of the cable.

6. The cable according to claim 5, wherein the third insulator is configured in a flat shape in which the longest straight line connecting the two points on the outer periphery of the third insulator is larger in length than a straight line connecting two points on the outer periphery of the third insulator, the straight line being orthogonal to the longest straight line connecting the two points on the outer periphery of the third insulator.

7. The cable according to claim 5, wherein the third insulator is configured so that a straight line connecting two points on the outer periphery of the third insulator does not cross the two imaginary tangential lines, the straight line being orthogonal to the longest straight line connecting the two points on the outer periphery of the third insulator.

8. The cable according to claim 6, wherein the third insulator is configured so that the straight line does not cross the two imaginary tangential lines.
